(19) United States
(12) Patent Application Publication
(10) Pub. No.: US 2026/0237687 A1
(43) Pub. Date: Aug. 13, 2026

(54) PRECIOUS METAL-TRANSITION METAL OXIDES ELECTROCATALYST AND METHODS OF MAKING AND USING THE SAME

(71) Applicant: UCHICAGO ARGONNE, LLC, Chicago, IL (US)

(72) Inventors: Yuzi Liu, Woodridge, IL (US); Gengnan Li, Downers Grove, IL (US)

(21) Appl. No.: 19/532,826

(22) Filed: Feb. 6, 2026

Related U.S. Application Data
(60) Provisional application No. 63/755,853, filed on Feb. 7, 2025.

(51) Int. Cl. H01M 4/90; H01M 4/92

(52) U.S. Cl. CPC H01M 4/9016; H01M 4/92

(57) ABSTRACT

A method of making an electrocatalyst is provided herein. The method includes admixing a precious metal oxide precursor with a transition metal oxide precursor to form an admixture, drying the admixture, and heating the admixture to a temperature of about 250° C. to about 500° C. A decomposition temperature of the transition metal oxide precursor and a decomposition temperature of the precious metal oxide precursor have a difference of no more than 100° C. Upon heating, the precious metal oxide precursor and the transition metal oxide precursor decompose substantially simultaneously to form nanocrystals having a transition metal oxide core and at least one precious metal oxide layer surrounding the core. Each layer of precious metal oxide is an atomically thin layer. Electrocatalysts for the oxygen evolution reaction (OER) and hydrocarbon oxidation are also provided.

### CROSS-REFERENCE TO RELATED APPLICATIONS

The benefit of priority of U.S. Provisional Application 63/755,853 filed on Feb. 7, 2025, is hereby claimed and the disclosure thereof is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates to electrocatalysts and methods of making the same; and more particularly to electrocatalysts and methods of making the same that comprise nanocrystals of transition metal oxides (e.g. cobalt oxide) with atomically thin layers of precious metal oxides (e.g. iridium oxide).

### BACKGROUND

Alkanes are naturally abundant and cheap carbon containing raw material which serve as attractive substrates for the production of value added organic chemicals (alcohols, ketones, aldehydes and carboxylic acids). Unfortunately, the chemical inertness of these compounds is a considerable limitation towards their vast application for direct syntheses of oxygenated products under relatively mild conditions. Methane, the smallest alkane, is considered particularly stable and unreactive. In fact, the direct oxidation of methane to methanol or formate remains a significant challenge for operation at a larger scale. Central to this challenge is the low reactivity of methane at conditions that can facilitate product recovery.

The electrocatalytic production of hydrogen (H₂), a high energy density clean fuel, from water splitting using renewable electricity has been considered a promising strategy for a decarbonized future. Compared to the hydrogen evolution reaction (HER) at the cathode, the oxygen evolution reaction (OER) at the anode in a water electrolyzer requires much higher overpotentials due to its sluggish kinetics of the complex four-electron transfer process. Moreover, for acidic OER, the use of a large amount of iridium oxide (IrO₂) at the anode is a major obstacle for the large-scale commercialization of water electrolysis. Many efforts have been made to reduce the amount of IrO₂ while maintaining its high OER activity by modifying the electronic structure and coordination of Ir to optimize the adsorption energy of the intermediates.

Among various materials, Ir—CoOₓ stands out as a cost-effective electrocatalyst for hydrocarbon oxidation as well as acidic OER with promising performance. Recent studies have demonstrated that the Ir atoms can be incorporated into the spinel Co₃O₄ framework due to the flexible composition and versatile electronic structure of Co₃O₄. The resulting single atom electrocatalysts with a unique electronic structure exhibit excellent activity with the OER and hydrocarbon oxidation.

Nevertheless, several challenges remain in utilizing Ir—Co₃O₄ as OER or hydrocarbon oxidation electrocatalysts. One challenge is to improve the stability of Ir—Co₃O₄ electrocatalyst at high current densities. Moreover, the synthesis of high surface area Co₃O₄ typically involves multiple steps and the use of high-cost precursors, which potentially limits large-scale applications. Furthermore, although doping Ir atoms into the Co₃O₄ bulk structure significantly improves the conductivity, a large fraction of the active Ir—O—Co sites in the bulk is not accessible by water or hydrocarbon molecules, which hinders the efficient use of Ir for hydrocarbon oxidation or acidic OER. Therefore, substantial advancements in both material synthesis and long-term stability are required for Ir—Co₃O₄ electrocatalysts to operate in practical water electrolysis and hydrocarbon oxidation applications.

### SUMMARY

In accordance with the disclosure, a method of making an electrocatalyst can include admixing a precious metal oxide precursor with a transition metal oxide precursor, drying the admixture, heating the admixture, wherein a decomposition temperature of the transition metal oxide precursor and a decomposition temperature of the precious metal oxide precursor have difference of no more than 100° C., and upon heating the precious metal oxide precursor and the transition metal oxide precursor decompose substantially simultaneously and thereby form nanocrystals having a transition metal oxide core and at least one precious metal oxide layer surrounding the core, wherein each layer of precious metal oxide is an atomically thin layer.

By way of example, methods in accordance with the disclosure can use an incipient wetness impregnation approach to fabricate Ir—Co₃O₄ electrocatalysts with different structures of IrOₓ over Co₃O₄ nanocrystals. Benefiting from the polymeric coordination of cobalt oxalate, the simultaneous decomposition of Ir and Co precursors during heating leads to the formation of an atomically thin layer of IrOₓ that is uniformly dispersed on the surface of Co₃O₄ nanocrystals. The structure containing two atomic layers of IrOₓ is highly ordered and it remains stable under OER conditions. The layered structure also allows the more efficient utilization of the active Ir species. The facile sample preparation method offers the opportunity for the scale-up fabrication of active, stable, and lower-cost Ir—Co₃O₄ OER electrocatalysts for practical applications.

In accordance with the disclosure, an electrocatalyst for a chemical process can include a plurality of nanocrystals, each nanocrystal comprising a transition metal oxide core and one or more layers of precious metal oxide surrounding the core, wherein each layer of precious metal oxide is an atomically thin layer and has a substantially uniform thickness of about 50 pm to about 500 pm, the precious metal is present in an amount of about 1 mol % to about 50 mol % based on the total weight of the electrocatalyst, and the chemical process can include the oxygen evolution reaction or hydrocarbon oxidation.

### BRIEF DESCRIPTION OF THE DRAWINGS

FIG. 1 shows a schematic of the electrocatalysts of the disclosure applied to the Oxygen evolution reaction (OER).

FIG. 2 shows the TGA analyses for Co₃O₄, an electrocatalyst in accordance with the disclosure and a comparator.

FIG. 3 shows the X-ray diffraction (XRD) pattern of Co₃O₄ and an electrocatalyst in accordance with the disclosure.

FIG. 4 shows the Raman spectra of Co₃O₄ and an electrocatalyst in accordance with the disclosure.

FIG. 5 shows the high-angle annular dark-field scanning transmission electron microscopy (HADDF-STEM) analysis of an electrocatalyst in accordance with the disclosure.

FIGS. 6A-D show the in situ E-TEM analysis of the formation of an electrocatalyst in accordance with the disclosure.

FIGS. 7A-D show the HADDF-STEM analysis and element mapping of an electrocatalyst in accordance with the disclosure.

FIG. 8 shows Linear sweep voltammetry (LSV) curves with varied Ir loading in O₂ saturated 0.1M HClO₄ during catalysis of the Oxygen evolution reaction (OER) with an electrocatalyst in accordance with the disclosure.

FIG. 9 shows the comparison of the mass activity of different electrocatalysts during catalysis of the OER including electrocatalysts in accordance with the disclosure.

FIG. 10 shows the chronopotentiometry stability of an electrocatalyst in accordance with the disclosure.

FIG. 11 shows the chronopotentiometry stability of an electrocatalyst in accordance with the disclosure.

FIG. 12 shows a schematic of the MEA device.

FIG. 13 shows the chronopotentiometry stability during catalysis of the OER with Nafion-115 (N115).

FIG. 14 shows the current-voltage polarization (I-V) curve during catalysis of the OER with commercial IrO₂ and an electrocatalyst in accordance with the disclosure.

FIG. 15 shows the mass activity during catalysis of the OER with commercial IrO₂ and an electrocatalyst in accordance with the disclosure.

FIG. 16 shows the in situ Ir L₃-edge XANES spectra of electrocatalysts in accordance with the disclosure under different conditions.

FIG. 17 shows the in situ Ir L₃-edge XANES spectra of electrocatalysts in accordance with the disclosure under different conditions.

FIG. 18 shows the in situ Ir L₃-edge EXAFS spectra in R space of electrocatalysts in accordance with the disclosure under different conditions.

FIG. 19 shows the in situ Ir L₃-edge EXAFS spectra in R space of electrocatalysts in accordance with the disclosure under different conditions.

FIG. 20 shows the concentration of products after hydrocarbon oxidation catalyzed with an electrocatalyst in accordance with the disclosure.

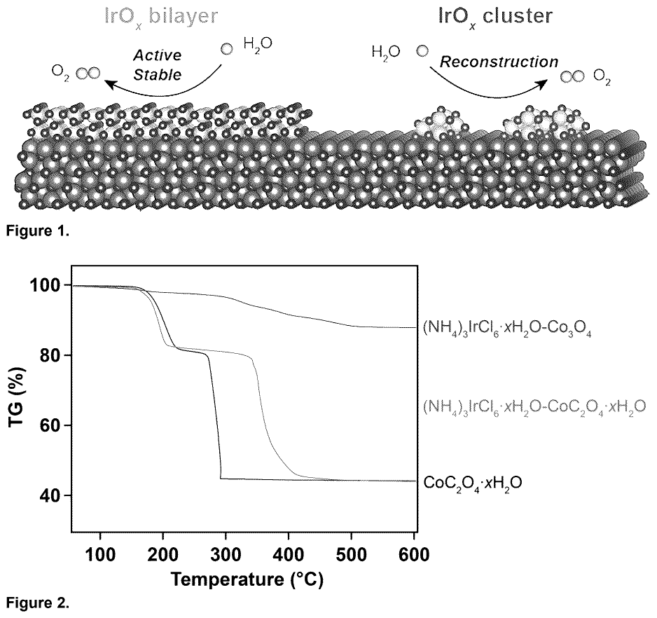

### DETAILED DESCRIPTION

Electrocatalysts in accordance with the disclosure include a plurality of nanocrystals that each have a transition metal oxide core surrounded by one or more atomically thin layers of a precious metal oxide. The electrocatalysts are useful for a variety of chemical processes, for example, oxygen evolution reaction (OER) and hydrocarbon oxidation. The one or more layers of precious metal oxide can have substantially uniform or uniform thickness. As used herein, the term “atomically thin layer” refers to a film of metal or metal oxide comprised of one layer of metal atoms or metal oxide molecules or their mixture, i.e., a monolayer.

The electrocatalysts of the disclosure can be formed by admixing a precious metal oxide precursor with a transition metal oxide precursor, then drying the admixture and heating the admixture. For example, the admixture can be dried and heated to a temperature of about 250° C. to about 500° C. Advantageously, it has been found that by selecting precious metal precursor and transition metal precursor with decomposition temperature that are different by no more than 100° C., the precursors can be decomposed in the method of the disclosure substantially simultaneously or simultaneously. This has been beneficially observed to allow for the formation of nanocrystals with a transition metal oxide core and at least one precious metal oxide layer surrounding the core, wherein each layer of precious metal oxide is an atomically thin layer.

In use, for example, the electrocatalyst can be incorporated into an anode of an electrochemical cell and exposed to a source material selected based on the desired reaction. The electrochemical cell can otherwise be conventionally designed, further including a cathode, an electrolyte, and an electrical source. Application of an electrical bias to the anode while the electrocatalyst is in contact with the source can result in decomposed into a plurality of intermediates, for example, OER or hydrocarbon intermediates. Continued application of the electrical bias can further convert the intermediates into a desired product. For example, in OER reactions, the OER intermediates can be converted into oxygen gas, while in hydrocarbon oxidation reactions, the hydrocarbon intermediates can be converted into carboxylates.

### Methods of Making Electrocatalysts

In the methods of the disclosure, the precious metal oxide precursor and the transition metal oxide precursor can be admixed using any known methods including but not limited to incipient wetness impregnation, and ball milling. For example, the electrocatalyst can be synthesized using a facile incipient wetness impregnation method. In this method, the precious metal oxide precursor is first dissolved in water to form a precursor solution. The precursor solution is then added dropwise to the transition metal oxide precursor to form an admixture. The dropwise addition of the precursor solution to the transition metal oxide precursor facilitates uniform distribution of the precious metal species throughout the transition metal oxide precursor material.

The precious metal oxide can be any one or more of an oxide of iridium, platinum, gold, ruthenium, and rhodium. Precursors of the precious metal oxides can be, for example, salts of the oxide. Generally, any precious metal oxide precursor that can provide a source of the precious metal, which in turn can be converted to precious metal oxide during the heating step of the method, can be used. For example, for methods forming electrocatalysts having iridium oxide, examples of precious metal oxide precursors can include, ammonium hexachloroiridate (III) hydrate ((NH₄)₃IrCl₆·xH₂O), iridium trichloride (IrCl₃·xH₂O), sodium hexachloroiridate (Na₃IrCl₆), potassium hexachloroiridate (K₃IrCl₆), hexachloroiridic acid (H₂IrCl₆), potassium hexachloroiridate(IV) (K₂IrCl₆), or iridium acetylacetonate (Ir(O₂C₅H₇)₃).

The transition metal oxide can be any one or more of an oxide of cobalt, iron, nickel, manganese, or copper. Precursors of the transition metal oxides can be, for example, salts of the transition metal such as oxalates, carbonates, hydroxides, nitrates, and chlorides. In general, any transition metal oxide precursor that provides a polymeric coordination structure and can provide a source of the transition metal, which in turn can be converted to transition metal oxide during the heating step of the method, can be used. For example, the precursor can include one or more of an oxalate, a carbonate, a hydroxide, and a nitrate of one or more of iron, nickel, copper, manganese, and cobalt. For example, for methods forming electrocatalysts having cobalt oxide, examples of transition metal oxide precursors can include cobalt oxalate, cobalt carbonate, cobalt hydroxide, cobalt nitrate, or cobalt chloride. For example, for methods forming electrocatalysts having oxides of one or more of iron, nickel, oxalate, or copper, the transition metal oxide precursor can be iron oxalate, nickel oxalate, manganese oxalate, or copper oxalate, respectively. For example, for methods forming electrocatalysts having oxides of one or more of iron, nickel, oxalate, or copper, the transition metal oxide precursor can be iron carbonate, nickel carbonate, manganese carbonate, or copper carbonate, respectively. For example, for methods forming electrocatalysts having oxides of one or more of iron, nickel, oxalate, or copper, the transition metal oxide precursor can be iron hydroxide, nickel hydroxide, manganese hydroxide, or copper hydroxide, respectively. For example, for methods forming electrocatalysts having oxides of one or more of iron, nickel, oxalate, or copper, the transition metal oxide precursor can be iron nitrate, nickel nitrate, manganese nitrate, or copper nitrate, respectively. For example, for methods forming electrocatalysts having oxides of one or more of iron, nickel, oxalate, or copper, the transition metal oxide precursor can be iron chloride, nickel chloride, manganese chloride, or copper chloride, respectively.

The admixture is then dried. The drying step removes water from the admixture while maintaining the distribution of the precious metal oxide precursor on the transition metal oxide precursor. Generally, the drying step can be performed at a temperature and for a duration of time necessary to remove water without decomposing the admixture. The drying step can be performed for a duration of time necessary to reduce the water content to about 30 wt % or less, for example. For example, the drying step can be performed at a temperature in a range of about 50° C. to about 70° C. and can range from about 1 hour to about 24 hours. For example, the drying step can be performed at a temperature in a range of about 50° C. to about 60° C., about 50° C. to about 65° C., about 50° C. to about 70° C., about 55° C. to about 65° C., about 55° C. to about 70° C., or about 65° C. to about 70° C. For example, the duration of the drying step can range from about 1 hour to about 18 hours, about 2 hours to about 18 hours, about 1 hour to about 12 hours, about 2 hours to about 12 hours, about 1 hour to about 16 hours, about 2 hours to about 16 hours, about 6 hours to about 24 hours, about 6 hours to about 18 hours, about 6 hours to about 16 hours, or about 6 hour to about 12 hours. For example, the admixture can be dried at about 60° C., overnight.

Generally, after drying, the dried admixture is subjected to heating, whereupon the precious metal oxide precursor and the transition metal oxide precursor decompose substantially simultaneously due to the similar decomposition temperatures of the two precursors. The admixture can be heated according to known methods in the art including but not limited to heating in a furnace, pyrolysis, Joule heating and laser heating, and is not particularly limiting. The air atmosphere during heating facilitates oxidation of the precursor materials to form the respective metal oxides. The combination of the heating temperature, heating rate, and duration in air provides conditions for the simultaneous decomposition of the precious metal oxide precursor and the transition metal oxide precursor. The simultaneous decomposition leads to the formation of nanocrystals having a transition metal oxide core with at least one atomically thin layer of precious metal oxide surrounding the core.

For example, the heating can be calcination. During heating, the admixture can be heated to a temperature of about 250° C. to about 500° C. for about 4 hours. For example, the admixture can be heated to a temperature in a range of about 250° C. to about 400° C. For example, the admixture can heated to a temperature in a range of about 250° C. to about 350° C. For example, the admixture can be heated to a temperature in a range of about 300° C. to about 400° C. for example, the admixture can be heated to a temperature of about 350° C.

The admixture may be heated at a rate in a range of about 0.5° C./min to about 30.0° C./min during heating. For example, suitable heating rates can include, about 0.5° C./min to about 20.0° C./min, about 0.5° C./min to about 15.0° C./min, or about 0.5° C./min to about 10° C./min. For example, the heating rate can be about 1.0° C./min to about 30.0° C./min, 1.0° C./min to about 25.0° C./min, about 1.0° C./min to about 20.0° C./min, about 1.0° C./min to about 15.0° C./min, about 1.0° C./min to about 10.0° C./min, about 1.0° C./min to about 5.0° C./min, or about 1.0° C./min to about 2.5° C./min. For example, the heating rate can be about 1.5° C./min to about 30.0° C./min, 1.5° C./min to about 25.0° C./min, about 1.5° C./min to about 20.0° C./min, about 1.5° C./min to about 15.0° C./min, about 1.5° C./min to about 10.0° C./min, about 1.5° C./min to about 5.0° C./min, or about 1.5° C./min to about 2.5° C./min. For example, the heating rate can be about 2.0° C./min to about 30.0° C./min, 2.0° C./min to about 25.0° C./min, about 2.0° C./min to about 20.0° C./min, about 2.0° C./min to about 15.0° C./min, about 2.0° C./min to about 10.0° C./min, about 2.0° C./min to about 5.0° C./min, or about 2.0° C./min to about 2.5° C./min. For example, the heating rate can be about 5.0° C./min to about 30.0° C./min, 5.0° C./min to about 25.0° C./min, about 5.0° C./min to about 20.0° C./min, about 5.0° C./min to about 15.0° C./min, or about 5.0° C./min to about 10.0° C./min. For example, the heating rate can be about 0.5° C./min, about 1.0° C./min, about 1.5° C./min, about 2.0° C./min, about 2.5° C./min, about 3.0° C./min, about 3.5° C./min, about 4.0° C./min, about 4.5° C./min, about 5.0° C./min, about 5.5° C./min, about 6.0° C./min, about 6.5° C./min, about 7.0° C./min, about 7.5° C./min, about 8.0° C./min, about 8.5° C./min, about 9.0° C./min, about 9.5° C./min, about 10.0° C./min, about 10.5° C./min, about 11.0° C./min, about 11.5° C./min, about 12.0° C./min, about 12.5° C./min, about 13.0° C./min, about 13.5° C./min, about 14.0° C./min, about 14.5° C./min, about 15.0° C./min, about 15.5° C./min, about 16.0° C./min, about 16.5° C./min, about 17.0° C./min, about 17.5° C./min, about 18.0° C./min, about 18.5° C./min, about 19.0° C./min, about 19.5° C./min, about 20.0° C./min, about 20.5° C./min, about 21.0° C./min, about 21.5° C./min, about 22.0° C./min, about 22.5° C./min, about 23.0° C./min, about 23.5° C./min, about 24.0° C./min, about 24.5° C./min, about 25.0° C./min, about 25.5° C./min, about 26.0° C./min, about 26.5° C./min, about 27.0° C./min, about 27.5° C./min, about 28.0° C./min, about 28.5° C./min, about 29.0° C./min, about 29.5° C./min, or about 30.0° C./min.

It has advantageously been found that by selecting the transition metal oxide and precious metal oxide precursors to have decomposition temperatures that have a difference of no more than 100° C., the substantially simultaneous decomposition of the precursors can be achieved with the method of the disclosure. Without intending to be bound by theory, it is believed that the polymeric coordination structure of the transition metal oxide precursor, such as, for example cobalt oxalate, can further facilitate the simultaneous decomposition with the precious metal oxide precursor, such as, for example (ammonium hexachloroiridate (III) hydrate). As a result of the simultaneous decomposition, nanocrystals are formed having a transition metal oxide core with at least one atomically thin layer of precious metal oxide surrounding the core. The atomically thin layer of precious metal oxide was observed to be uniformly dispersed on the surface of the transition metal oxide nanocrystals.

Selection of the amount of precious metal in the electrocatalyst can be used to achieve different structural formations of the precious metal oxide on the transition metal oxide core, and such selections can be made based in part on a relative amount of transition metal oxide being present and/or type of precursors being used in making the electrocatalyst. Generally, the precious metal is present in an amount of about 1 mol % to about 50 mol % based on the total weight of the electrocatalyst. When the precious metal is present in an amount of about 15 mol %, such as about 16 mol %, the precious metal oxide is expected to assemble into well-defined bilayer structures on the surface of the transition metal oxide nanocrystals. The bilayer structures comprise two atomic layers of precious metal oxide that are uniformly dispersed on the surface of the transition metal oxide core. The bilayer configuration at this loading level provides a balance between precious metal utilization and surface coverage.

Generally, if the amount of precious metal is too low, thin discontinuous atomic layers are expected to form, while if the amount of precious metal is too high, aggregation occurs and clusters are expected to form. When the precious metal is present in an amount of less than 1 mol %, the precious metal oxide is expected to form thinner and discontinued atomic layers on the surface of the transition metal oxide nanocrystals. The discontinued atomic layers result from insufficient precious metal content to provide complete coverage of the transition metal oxide surface. The thinner layers at lower loading levels is understood to provide reduced surface coverage as compared to higher loading levels. When the precious metal is above 50 mol %, the precious metal oxide is expected to aggregate into clusters rather than maintaining layered configurations on the transition metal oxide surface. The cluster formation at higher loading levels results from excess precious metal content that exceeds the capacity for uniform layer formation on the transition metal oxide surface.

### Electrocatalysts of the Disclosure

In accordance with the disclosure, the electrocatalyst can include a plurality of nanocrystals where each nanocrystal comprises a transition metal oxide core and one or more atomically thin layers of precious metal oxide surrounding the core. The atomically thin layers of precious metal oxide form a shell structure that encapsulates the transition metal oxide core.

Generally, each nanocrystal can have at least one layer of the precious metal oxide and can include up to about 5 layers of precious metal oxide. The number of layers of precious metal oxide may be controlled by adjusting the ratio of the precious metal precursor to the transition metal oxide precursor during synthesis. At lower ratios, fewer layers of precious metal oxide form on the transition metal oxide core. At higher ratios, additional layers of precious metal oxide may form, up to about 5 layers, before cluster formation begins to occur. For example, each nanocrystal comprises about 1 to about 5 layers of the precious metal oxide surrounding the core. For example, each nanocrystal can have 1, 2, 3, 4, or 5 layers of precious metal oxide surrounding the core.

Generally, each layer of the precious metal oxide has a substantially uniform thickness of about 50 pm to about 500 pm. The substantially uniform thickness of each atomically thin layer results from the simultaneous decomposition of the precious metal oxide precursor and the transition metal oxide precursor during the calcination process. The uniform thickness of the atomically thin layers provides consistent coverage of the transition metal oxide core surface. For example, the thickness of each layer of precious metal oxide can be about 50 pm to about 500 pm. For example, the thickness of each layer of precious metal oxide can be about 75 pm to about 500 pm. For example, the thickness of each layer of precious metal oxide can be about 100 pm to about 500 pm. For example, the thickness of each layer of precious metal oxide can be about 125 pm to about 500 pm. For example, the thickness of each layer of precious metal oxide can be about 150 pm to about 500 pm. For example, the thickness of each layer of precious metal oxide can be about 175 pm to about 500 pm. For example, the thickness of each layer of precious metal oxide can be about 200 pm to about 500 pm. For example, the thickness of each layer of precious metal oxide can be about 50 pm to about 400 pm. For example, the thickness of each layer of precious metal oxide can be about 100 pm to about 400 pm. For example, the thickness of each layer of precious metal oxide can be about 200 pm to about 400 pm. For example, the thickness of each layer of precious metal oxide can be about 50 pm to about 300 pm. For example, the thickness of each layer of precious metal oxide can be about 100 pm to about 300 pm. For example, the thickness of each layer of precious metal oxide can be about 200 pm to about 300 pm. For example, the thickness of each layer of precious metal oxide can be about 250 pm to about 300 pm. For example, the thickness of each layer of precious metal oxide can is about 260 pm to about 290 pm. For example, the thickness of each layer of precious metal oxide is about 265 pm to about 280 pm, about 265 pm to about 275 pm, about 265 pm to about 270 pm, about 270 pm to about 280 pm, about 270 pm to about 275 pm, or about 275 pm to about 280 pm. For example, the thickness of each layer of precious metal oxide is about 265 pm. For example, the thickness of each layer of precious metal oxide is about 270 pm. For example, the thickness of each layer of precious metal oxide is about 275 pm. For example, the thickness of each layer of precious metal oxide is about 280 pm.

The atomically thin layers of precious metal oxide form bonds between each layer and at the interface with the transition metal oxide core. The formation of these interfacial bonds results from the interaction between oxygen atoms of the precious metal oxide layers and transition metal atoms at the surface of the transition metal oxide core. For example, when the precious metal oxide is iridium oxide and the transition metal oxide core is cobalt oxide, Ir—O—Ir bonds are present between the atomically thin layers, Co—O—Co bonds are present in the core, and Ir—O—Co bonds form at the interface. These Ir—O—Co interfacial bonds provide structural connectivity between the precious metal oxide layers and the transition metal oxide core.

For example, it has been demonstrated that an atomically thin layer of iridium oxide (IrOₓ) can be uniformly disposed onto cobalt oxide (Co₃O₄) nanocrystals. Further, these nanocrystals provide electrocatalysts with improved mass activity, which in turn reduces the amount of precious metal oxide (IrOₓ) required while also maintaining or improving reaction kinetics and stability as compared to conventional electrocatalysts.

Electrocatalysts of the disclosure can have a mass activity of about 300 A g_{(precious metal)}⁻¹ to about 1100 A g_{(precious metal)}⁻¹, about 500 A g_{(precious metal)}⁻¹ to about 1100 A g_{(precious metal)}⁻¹, about 700 A g_{(precious metal)}⁻¹ to about 1100 A g_{(precious metal)}⁻¹, about 900 A g_{(precious metal)}⁻¹ to about 1100 A g_{(precious metal)}⁻¹, about 300 A g_{(precious metal)}⁻¹ to about 900 A g_{(precious metal)}⁻¹, about 300 A g_{(precious metal)}⁻¹ to about 700 A g_{(precious metal)}⁻¹, about 300 A g_{(precious metal)}⁻¹ to about 500 A g_{(precious metal)}⁻¹, about 500 A g_{(precious metal)}⁻¹ to about 1100 A g_{(precious metal)}⁻¹, about 500 A g_{(precious metal)}⁻¹ to about 900 A g_{(precious metal)}⁻¹, about 500 A g_{(precious metal)}⁻¹ to about 700 A g_{(precious metal)}⁻¹, about 700 A g_{(precious metal)}⁻¹ to about 1100 A g_{(precious metal)}⁻¹, about 700 A g_{(precious metal)}⁻¹ to about 900 A g_{(precious metal)}⁻¹, or about 900 A g_{(precious metal)}⁻¹ to about 1100 A g_{(precious metal)}⁻¹, at an overpotential of about 310 mV. For example, the precious metal oxide can be iridium oxide (IrOₓ) and the electrocatalyst can have a mass activity of about 300 A g_{Ir}⁻¹ to about 1100 A g_{Ir}⁻¹, about 500 A g_{Ir}⁻¹ to about 1100 A g_{Ir}⁻¹, about 700 A g_{Ir}⁻¹ to about 1100 A g_{Ir}⁻¹, about 900 A g_{Ir}⁻¹ to about 1100 A g_{Ir}⁻¹, about 300 A g_{Ir}⁻¹ to about 900 A g_{Ir}⁻¹, about 300 A g_{Ir}⁻¹ to about 700 A g_{Ir}⁻¹, about 300 A g_{Ir}⁻¹ to about 500 A g_{Ir}⁻¹, about 500 A g_{Ir}⁻¹ to about 1100 A g_{Ir}⁻¹, about 500 A g_{Ir}⁻¹ to about 900 A g_{Ir}⁻¹, about 500 A g_{Ir}⁻¹ to about 700 A g_{Ir}⁻¹, about 700 A g_{Ir}⁻¹ to about 1100 A g_{Ir}⁻¹, about 700 A g_{Ir}⁻¹ to about 900 A g_{Ir}⁻¹, or about 900 A g_{Ir}⁻¹ to about 1100 A g_{Ir}⁻¹, at an overpotential of about 310 mV. For example, the electrocatalyst can have a mass activity of about 300 A g_{Ir}⁻¹ to about 1100 A g_{Ir}⁻¹ at an overpotential of about 310 mV. For example, the electrocatalyst can have a mass activity of about 1000 A g_{Ir}⁻¹ at an overpotential of about 310 mV.

The mass activity represents the normalized current generated per unit mass of precious metal in the electrocatalyst during the oxygen evolution reaction. The mass activity reflects the efficient utilization of the precious metal species in the atomically thin layers on the transition metal oxide core surface, where the precious metal atoms are accessible to water molecules for participation in the electrochemical reaction. As reported herein, the mass activity was determined using the Mass Activity Test Method.

### Mass Activity Test Method

A standard three-electrode glass cell with a platinum counter electrode, an Ag/AgCl reference electrode, and a glassy carbon electrode was used with O₂-saturated 0.1M HClO₄ electrolyte and a rotating disk electrode (RDE) at a rotating speed of 1600 rpm. The glassy carbon electrode was loaded with electrocatalyst by dispersing 5.0 mg freshly synthesized electrocatalyst powder in a mixture solution containing 742 μL DI water, 248 μL 2-propanol and 10 μL 5% Nafion solution, followed by sonication for 1 h in an ice-bath. Then, 5 μL ink was applied to a pre-polished glassy carbon electrode (diameter=5 mm, area 0.196 cm²). The current was measured as the applied potential was fixed to an overpotential of 310 mV. The mass activity was determined from the measured current and the mass of electrocatalyst loaded onto the electrode.

The reaction kinetics at the electrocatalyst surface were investigated with a Tafel slope, which characterizes the relationship between the overpotential and the logarithm of the current density during the chemical process being catalyzed. For example, an electrocatalyst prepared as described in Example 1 was demonstrated to exhibit a Tafel slope of about 52.0 mV dec⁻¹ for the oxygen evolution reaction, which was lower compared to commercial catalysts The lower Tafel slope of the electrocatalyst compared to commercial catalysts indicates that the electrocatalyst achieves a given increase in current density with a smaller increase in overpotential, reflecting more efficient transfer kinetics.

Electrocatalysts in accordance with the disclosure can have a normalized current density of about 0.30 to about 0.15 mA cm_{ECSA}⁻², about 0.30 to about 0.20 mA cm_{ECSA}⁻², about 0.30 to about 0.25 mA cm_{ECSA}⁻², about 0.25 to about 0.15 mA cm_{ECSA}⁻², about 0.20 to about 0.15 mA cm_{ECSA}⁻², or about 0.25 to about 0.20 mA cm_{ECSA}⁻². For example, the electrocatalyst can exhibit a current density of about 0.30 to about 0.15 mA cm_{ECSA}⁻². For example, the electrocatalyst can exhibit a current density of about 0.30 to about 0.20 mA cm_{ECSA}⁻².

The normalized current density, as used herein, is the normalized amount of electric current flowing per unit of cross-sectional area of electrocatalyst. As reported herein, the current density was determined using the Current Density Test Method.

### Current Density Test Method

A standard three-electrode glass cell with a platinum counter electrode, an Ag/AgCl reference electrode, and a glassy carbon electrode was used with O₂-saturated 0.1M HClO₄ electrolyte and a rotating disk electrode (RDE) at a rotating speed of 1600 rpm. The 0.1M perchloric acid (HClO₄) electrolyte was prepared by diluting 70% HClO₄ with DI water. All the potentials were corrected with 85% iR-compensation. The glassy carbon electrode was loaded with electrocatalyst by dispersing 5.0 mg freshly synthesized electrocatalyst powder in a mixture solution containing 742 μL DI water, 248 μL 2-propanol and 10 μL 5% Nafion solution, followed by sonication for 1 h in an ice-bath. Then, 5 μL ink was applied to a pre-polished glassy carbon electrode (diameter=5 mm, area 0.196 cm²).

Given the mass activity of the sample, the current density was determined and normalized by evaluating the electrochemical surface area (ECSA). ECSA was estimated by methods known in the art, including but not limited to, cyclic voltammetry (CV) or electrochemical impedance spectroscopy (EIS). The current density was determined by multiplying the mass activity by the ECSA.

Electrocatalysts of the disclosure were advantageously found to maintain stable performance under prolonged operation in acidic conditions due to the atomically thin layers of precious metal oxide on the transition metal oxide core which provide resistance to degradation under the corrosive and oxidative conditions encountered during oxygen evolution in acidic electrolytes. As illustrated in Example 3, it was observed that electrocatalysts of the disclosure had a lower degradation rate than traditional electrocatalysts at a given current density. The degradation rate of the electrocatalyst describes the decline in maximum power output, capacity, or voltage efficiency of the electrocatalyst and results from irreversible physical or chemical changes. Degradation rates are reported herein with reference to a specific current density used when measured using the Stability Test Method described herein.

### Stability Test Method

A standard three-electrode glass cell with a platinum counter electrode, an Ag/AgCl reference electrode, and a pre-polished Au working electrode (diameter=5 mm, area 0.196 cm²) was used with O₂-saturated 0.1M HClO₄ electrolyte and a rotating disk electrode (RDE) at a rotating speed of 1600 rpm. The 0.1M perchloric acid (HClO₄) electrolyte was prepared by diluting 70% HClO₄ with DI water. All the potentials were corrected with 85% iR-compensation. The pre-polished Au working electrode was loaded with electrocatalyst by dispersing 5.0 mg freshly synthesized electrocatalyst powder in a mixture solution containing 742 μL DI water, 248 μL 2-propanol and 10 μL 5% Nafion solution, followed by sonication for 1 h in an ice-bath. Then, 5 μL ink was applied to a pre-polished Au working electrode (diameter=5 mm, area 0.196 cm²).

The voltage of the electrocatalyst was measured over time as the applied current was kept constant at a pre-determined current density, such as 10, mA cm−² or 100 mA cm⁻². As the electrocatalyst degrades, the measured voltage decreases over time. From the time-resolved measurements, the slope of the best-fit line of the data is the degradation rate.

Electrocatalysts of the disclosure can have a degradation rate of about 0.01 mV h⁻¹ to about 0.10 mV h⁻¹ at a current density of about 10 mA cm⁻² and about 0.1 mV h⁻¹ to about 1.0 mV h⁻¹ at a current density of about 100 mA cm⁻². For example, at a current density of 10 mA cm⁻², an electrocatalyst prepared in accordance with the disclosure remained stable for 1000 hours with a degradation rate of 0.05 mV h⁻¹, while at a higher current density of 100 mA cm⁻², the electrocatalyst remained stable for 1000 hours with a degradation rate of 0.6 mV h⁻¹ using the Stability Test Method. For example, the degradation rate of the electrocatalyst is about 0.02 mV h⁻¹ to about 0.08 mV h⁻¹ at a current density of about 10 mA cm⁻². For example, the degradation rate of the electrocatalyst is about 0.05 mV h⁻¹ to about 0.06 mV h⁻¹ at a current density of about 10 mA cm⁻². For example, the degradation rate of the electrocatalyst is about 0.3 mV h⁻¹ to about 3.0 mV h⁻¹ at a current density of about 100 mA cm⁻². For example, the degradation rate of the electrocatalyst is about 0.5 mV h⁻¹ to about 1.5 mV h⁻¹ at a current density of about 100 mA cm⁻².

### Methods of Using the Electrocatalyst

In accordance with the disclosure, the electrocatalysts disclosed herein can be used for a variety of chemical processes, including but not limited to OER and hydrocarbon oxidation reactions. For example, electrocatalysts in accordance with the disclosure can be incorporated into conventional electrochemical cells for performing such reactions. By way of example, use of electrocatalysts in accordance with the disclosure can include disposing the electrocatalysts in an anode of an electrochemical cells, which further includes a cathode, an electrolyte, and an electrical source; applying an electrical bias to the anode. The electrocatalyst can then be exposed to a source having at least one target for the chemical reaction. For example, the source can include water or hydrocarbons. Upon contacting the electrocatalyst under the electrical bias, the source or target contained therein is converted to the desired end product. For example, water or a hydrocarbon can be decomposed into a plurality of OER or hydrocarbon intermediates upon initial contact with the electrocatalysts under the electrical bias and maintained contact and application of the electrical bias can convert the plurality of OER or hydrocarbon intermediates into oxygen gas or carboxylates, respectively.

The atomically thin precious metal oxide layers form (precious metal)-O-(transition metal) interfacial bonds with the underlying transition metal oxide core, establishing a robust interaction at the interface between the precious metal oxide shell and the transition metal oxide core. Without being bound by theory, this interfacial bonding configuration is expected to modify the adsorption energies of OER intermediates, including, but not limited to, OH, O, and OOH species, on the active precious metal sites. For example, when the electrocatalyst includes 1-10 atomically thin layers of precious metal oxide on the transition metal oxide, the electrocatalyst can exhibit higher activity as compared to both the pure precious metal (such as iridium oxide or palladium) or pure transition metal (such as cobalt oxide, iron oxide, nickel oxide, and copper oxide) due to the unique electronic properties of the (precious metal)-O-(transition metal) interface.

The electrocatalyst described herein may also be employed for hydrocarbon oxidation reactions. When exposed to hydrocarbon feedstocks under oxidizing conditions, the electrocatalyst facilitates the conversion of hydrocarbons to oxidized products such as alcohols, aldehydes, or carboxylic acids. The atomically thin layers of precious metal oxide on the transition metal oxide core provide active sites for the adsorption and activation of hydrocarbon molecules. The (precious metal)-O-(transition metal) interfacial bonds between the precious metal oxide layers and the transition metal oxide core can modify the electronic structure of the active sites, influencing the selectivity of the oxidation reaction toward partial oxidation products rather than complete combustion to carbon dioxide and water. The transition metal oxide core, such as cobalt oxide with spinel structure, may contribute to the hydrocarbon oxidation activity through participation of surface oxygen species in the oxidation mechanism. The electrocatalyst may be employed in electrochemical hydrocarbon oxidation processes where the oxidation reaction is driven by an applied potential, or in thermocatalytic hydrocarbon oxidation processes where the reaction is driven by elevated temperature in the presence of an oxidizing atmosphere. The nanocrystal structure of the electrocatalyst provides a high surface area for interaction with hydrocarbon molecules, and the atomically thin precious metal oxide layers provide efficient utilization of the precious metal species for the hydrocarbon oxidation reaction. For example, the electrocatalyst can catalyze the oxidation of hydrocarbons. For example, the electrocatalyst can catalyze the oxidation of methane.

The electrocatalysts described herein may also be employed in a variety of applications. In one application, the electrocatalyst may be incorporated into water electrolyzers for green hydrogen production. In water electrolyzers, the electrocatalyst facilitates the oxygen evolution reaction at the anode, enabling efficient splitting of water molecules to generate hydrogen gas as a clean energy carrier. The atomically thin layers of precious metal oxide on the transition metal oxide core provide active sites for the electrochemical oxidation of water while reducing the amount of precious metal required compared to conventional electrocatalysts. Additionally, the electrocatalyst may be used in proton exchange membrane (PEM) water electrolyzers operating under acidic conditions, where the (precious metal)-O-(transition metal) interfacial bonds between the precious metal oxide layers and the transition metal oxide core provide stability against dissolution in the acidic electrolyte.

The electrocatalyst may be incorporated into a membrane electrode assembly (MEA) configuration for electrochemical applications. The selection of the membrane type may depend on the desired application for the electrocatalyst. The content of precious metal in the electrocatalysts can be used to tailor performance, providing flexibility in balancing the electrocatalytic activity with the amount of precious metal utilized in the MEA.

Additionally, the electrocatalyst may be used in electrochemical oxidation processes. In one electrochemical oxidation process, the electrocatalyst may be employed for chlorine production from chloride ions. In chlorine production, the electrocatalyst catalyzes the oxidation of chloride ions at the anode to produce chlorine gas. The atomically thin precious metal oxide layers provide active sites for the chloride oxidation reaction while the transition metal oxide core provides structural support and may contribute to the catalytic activity. The electrocatalyst may provide improved reaction efficiency and selectivity in electrochemical chlorine production compared to conventional electrode materials. The electrocatalyst may also be employed in other electrochemical oxidation processes, such as oxidation of organic compounds for wastewater treatment or synthesis of chemical intermediates.

In another application, the electrocatalyst may be utilized in capacitors for energy storage. The nanocrystal structure of the electrocatalyst, comprising the transition metal oxide core with atomically thin precious metal oxide layers, provides a high surface area for charge storage. The transition metal oxide core, such as cobalt oxide with spinel structure, contributes to pseudocapacitive charge storage through reversible redox reactions at the electrode-electrolyte interface. The precious metal oxide layers may enhance the electrical conductivity of the electrode material and improve charge transfer kinetics during charging and discharging cycles. The electrocatalyst may be incorporated into supercapacitor electrodes to enhance charge storage capacity and cycling stability.

The electrocatalyst may also be employed in sensors. The electrochemical properties of the electrocatalyst enable sensitive detection of target analytes through changes in electrical signals upon interaction with the analyte species. The atomically thin precious metal oxide layers provide active sites for adsorption and electrochemical reaction of analyte molecules. The transition metal oxide core may contribute to the sensing response through changes in oxidation state or conductivity upon exposure to target species. The electrocatalyst may be incorporated into electrochemical sensor platforms for detection of gases, ions, or organic molecules in environmental monitoring, industrial process control, or biomedical diagnostics applications.

### Aspects of the Disclosure

Aspect 1. A method of making an electrocatalyst, comprising:
admixing a precious metal oxide precursor with a transition metal oxide precursor; drying the admixture;
heating the admixture, wherein a decomposition temperature of the transition metal oxide precursor and a decomposition temperature of the precious metal oxide precursor have difference of no more than 100° C.; and
upon heating the precious metal oxide precursor and the transition metal oxide precursor decompose substantially simultaneously and thereby form nanocrystals having a transition metal oxide core and at least one precious metal oxide layer surrounding the core;
wherein each layer of precious metal oxide is an atomically thin layer.

Aspect 2. The method of aspect 1, wherein admixing comprises dropwise adding the precious metal oxide precursor to the transition metal oxide precursor.

Aspect 3. The method of aspect 1 or 2, comprising selecting the ratio of the precious metal precursor to the transition metal oxide precursor such that two layers of iridium oxide deposit on the transition metal oxide nanocrystals.

Aspect 4. The method of any one of the preceding aspects, wherein the transition metal is one or more of cobalt, iron, nickel, manganese, and copper.

Aspect 5. The method of any one of the preceding aspects, wherein the transition metal oxide precursor comprises one or more of a transition metal carbonate, transition metal hydroxide, transition metal nitrate, transition metal chloride, and transition metal oxalate.

Aspect 6. The method of any one of the preceding aspects, wherein the transition metal oxide precursor is a transition metal oxalate.

Aspect 7. The method of any one of the preceding aspects, wherein the transition metal oxide precursor comprises one or more of cobalt oxalate, iron oxalate, nickel oxalate, manganese oxalate, and copper oxalate.

Aspect 8. The method of any one of aspects 1 to 5, wherein the transition metal oxide precursor comprises one or more of cobalt carbonate, cobalt hydroxide, cobalt nitrate, and cobalt chloride.

Aspect 9. The method of any one of the preceding aspects, wherein the transition metal oxide nanocrystals comprise a spinel structure.

Aspect 10. The method of any one of the preceding aspects, wherein the precious metal is one or more of iridium, platinum, gold, ruthenium, and rhodium.

Aspect 11. The method of any one of the preceding aspects, wherein the precious metal oxide precursor comprises a salt of iridium, platinum, gold, ruthenium, or rhodium.

Aspect 12. The method of any one of the preceding aspects, wherein the precious metal oxide precursor is an iridium salt.

Aspect 13. The method of any one of the preceding aspects, wherein the precious metal oxide precursor is ammonium hexachloroiridate (III) hydrate ((NH₄)₃IrCl₆·H₂O), iridium trichloride (IrCl₃ ·xH₂O), sodium hexachloroiridate (Na₃IrCl₆), potassium hexachloroiridate (K₃IrCl₆), hexachloroiridic acid (H₂IrCl₆), potassium hexachloroiridate(IV) (K₂IrCl₆), and iridium acetylacetonate (Ir(O₂C₅H₇)₃).

Aspect 14. The method of any one of the preceding aspects, wherein the admixture is heated to a temperature in a range of about 250° C. to about 400° C., about 250° C. to about 350° C., about 300° C. to about 400° C., or about 250° C. to about 500° C.

Aspect 15. The method of any one of the preceding aspects, wherein the admixture is heated to a temperature of about 350° C.

Aspect 16. The method of any one of the preceding aspects, further comprising heating the admixture with a rate in a range of about 0.5° C./min to about 2.0° C./min, about 0.5° C./min to about 1.5° C./min, about 1.0° C./min to about 2.0° C./min, or about 1.0° C./min to about 2.0° C./min.

Aspect 17. The method of aspect 15, wherein the admixture is heated with a rate of about 1.0° C./min.

Aspect 18. An electrocatalyst for a chemical process, comprising:
a plurality of nanocrystals, each nanocrystal comprising a transition metal oxide core and one or more layers of a precious metal oxide surrounding the core, wherein:
each layer of the precious metal oxide is an atomically thin layer and has a substantially uniform thickness of about 260 pm to about 290 pm, and
the precious metal oxide is present in an amount of about 1 mol % to about 50 mol % based on the total weight of the electrocatalyst.

Aspect 19. The electrocatalyst of aspect 18, wherein the transition metal oxide is one or more of cobalt oxide, iron oxide, nickel oxide, manganese oxide, and copper oxide.

Aspect 20. The electrocatalyst of aspect 18, wherein the precious metal oxide comprises one or more of iridium oxide, platinum oxide, gold oxide, ruthenium oxide, and rhodium oxide.

Aspect 21. The electrocatalyst of aspect 18 or 20, wherein the precious metal oxide is iridium oxide and thickness of each layer of iridium oxide is about 265 pm to about 280 pm.

Aspect 22. The electrocatalyst of aspect 18 or 20, wherein the transition metal oxide core is a cobalt oxide core.

Aspect 23. The electrocatalyst of any one of aspects 20 or 22, wherein the cobalt oxide core comprise face-centered cubic symmetry.

Aspect 24. The electrocatalyst of aspect 20 or 23, wherein the precious metal oxide is iridium oxide and the iridium oxide deposits on a (111) facet of the cobalt oxide core.

Aspect 25. The electrocatalyst of any one of aspects 18 to 24, wherein each nanocrystal comprises about 1 to about 5 layers of the precious metal oxide.

Aspect 26. The electrocatalyst of aspect 25, wherein each nanocrystal comprises 2 layers of precious metal oxide.

Aspect 27. The electrocatalyst of aspect 18 or 19, wherein the precious metal oxide is platinum oxide or gold oxide and the transition metal oxide core is nickel oxide or copper oxide.

Aspect 28. The electrocatalyst of aspect 18 or 19, wherein the precious metal oxide is ruthenium oxide or rhodium oxide and the transition metal oxide core is iron oxide or manganese oxide.

Aspect 29. The electrocatalyst of any one of aspects 18 to 26, wherein the precious metal oxide is iridium oxide and the transition metal oxide core is cobalt oxide.

Aspect 30. The electrocatalyst of aspect 29, wherein the iridium is present in an amount of about 15 mol %, based on the total weight of the electrocatalyst.

Aspect 31. The electrocatalyst of aspect 29, wherein the iridium is present in an amount of about 1.1 wt % to about 10.4 wt % based on the total weight of the electrocatalyst.

Aspect 32. The electrocatalyst of any one of aspects 18 to 31, wherein the chemical process is the oxygen evolution reaction (OER) or hydrocarbon oxidation.

Aspect 33. The electrocatalyst of aspect 32, wherein the chemical process is the oxygen evolution reaction (OER).

Aspect 34. The electrocatalyst of aspect 32, wherein the chemical process is hydrocarbon oxidation.

Aspect 35. The electrocatalyst of aspect 34, wherein the hydrocarbon oxidation is methane oxidation.

Aspect 36. The electrocatalyst of any one of aspects 18 to 35, wherein the electrocatalyst has a normalized current density of about 0.30 to about 0.15 mA cm_{ECSA}⁻².

Aspect 37. The electrocatalyst of aspect 36, wherein the normalized current density is about 0.27 to about 0.18 mA cm_{ECSA}^{-2.}

Aspect 38. The electrocatalyst of any one of aspects 18 to 37, wherein the electrocatalyst has a degradation rate of about 0.02 mV h⁻¹ to about 0.08 mV h⁻¹ at a current density of about 10 mA cm⁻².

Aspect 39. The electrocatalyst of aspect 38, wherein the degradation rate of is about 0.05 mV h⁻¹ to about 0.06 mV h⁻¹ at a current density of about 10 mA cm⁻².

Aspect 40. The electrocatalyst of any one of aspects 18 to 37, wherein the degradation rate of the electrocatalyst is about 0.3 mV h⁻¹ to about 3.0 mV h⁻¹ at a current density of about 100 mA cm⁻².

Aspect 41. The electrocatalyst of aspect 40, wherein the degradation rate of the electrocatalyst is about 0.5 mV h⁻¹ to about 1.5 mV h⁻¹ at a current density of about 100 mA cm⁻².

Aspect 42. The electrocatalyst of any one of aspects 18 to 41, wherein the electrocatalysts has a mass activity of about 300 A g_{(precious metal)}⁻¹ to about 1100 A g_{(precious metal)}⁻¹ at an overpotential of about 310 mV. p Aspect 43. The electrocatalyst of aspect 42, wherein the mass activity s about 1000 A g_{(precious metal)}⁻¹ at an overpotential of about 310 mV.

Aspect 44. A method of performing an oxygen evolution reaction, comprising:
providing an electrochemical cell, comprising:
   an anode, comprising the electrocatalyst of aspect 18;
   a cathode;
   an electrolyte; and
   an electrical source;
applying an electrical bias to the anode;
exposing the electrocatalyst to a source comprising water, wherein upon contacting the electrocatalyst under the electrical bias, the water of the source is decomposed into a plurality of OER intermediates; and
maintaining the electrical bias, thereby converting the plurality of OER intermediates into oxygen gas.

Aspect 45. A method of oxidizing hydrocarbons, comprising:
providing an electrochemical cell, comprising:
   an anode, comprising the electrocatalyst of aspect 18;
   a cathode;
   an electrolyte; and
   an electrical source;
applying an electrical bias to the anode;
exposing the electrocatalyst to a source comprising hydrocarbons, wherein upon contacting the electrocatalyst, the hydrocarbons decompose into a plurality of hydrocarbon intermediates; and
maintaining the electrical bias, thereby converting the plurality of hydrocarbon intermediates into carboxylic acids or carboxylates.

### EXAMPLES

The following examples are provided for illustration and are not intended to limit the scope of the invention.

### Materials & Methods

Commercial IrO₂ was purchased from Alfa Asear. All other chemicals were purchased from Sigma-Aldrich and used directly without further purification. Deionized (DI) water was supplied by a Millipore system.

Ir—Co₃O₄ electrocatalysts were prepared through a facile incipient wetness impregnation method using either polymeric cobalt oxalate (CoC₂O₄·xH₂O) or Co₃O₄ as support, as described below and in accordance with the methods of the disclosure.

TGA was performed on a Mettler Toledo 851 system in a temperature range of 50-600° C. with a heating rate of 10° C./min under 20 mL/min air flow. XRD data were collected on a Bruker D2 Phaser X-ray diffractometer with a scanning rate of 2° min⁻¹ from 10° to 80°. Raman spectra were collected on a RENISHAW inVia Raman spectroscope (laser excitation at 532 nm). ICP-OES analysis was performed on an Agilent 5110 Synchronous Vertical Dual View (SVDV) instrument. The loading amount of Ir on Co₃O₄ was determined by Energy Dispersive X-ray Spectroscopy (EDS) analysis on a Hitachi S-4700-II Scanning Electron Microscope (SEM) coupled with a Bruker EDS (Quantax). HADDF-STEM was conducted on a Talos F200X STEM system.

In situ E-TEM was performed on a FEI Titan 80-300 environmental transmission electron microscope, equipped with an objective-lens aberration corrector and a differential pumping system. This setup enabled a spatial resolution of approximately 0.8 Å, under elevated gas pressures and temperatures at the specimen site. The sample was loaded onto a Cu grid that was adapted to a Gatan heating holder. After 6×10⁻³ Torr O₂ was introduced into the chamber, the sample was heated to 350° C. under O₂ with a heating rate of 10° C. min⁻¹. In all STEM images, the scale bar is 5 nm.

In situ X-ray absorption spectroscopy (XAS) measurements of Ir L₃ and Co K-edges were carried out under the oxygen evolution reaction (OER) condition using beamline 7-BM (QAS, 10¹² ph s⁻¹ @ 10 keV) of the National Synchrotron Light Source II (NSLS-II) at Brookhaven National Laboratory (BNL). The in situ experiments were performed using a 3D printed acryl H-type cell. (Lee, J. H. et. al. Tuning the activity and selectivity of electroreduction of CO₂ to synthesis gas using bimetallic catalysts. Nature communications 2019, 10 (1), 3724.)

The working electrodes (1×1 cm²) were prepared with 5.0 mg of electrocatalyst and 10 μL 5 wt % Nafion, corresponding to an areal density of 5.0 mg_{cata} cm⁻², corresponding to 0.26 mg_{Ir} cm⁻². All potentials were converted to the scale of RHE. A Pt wire served as the counter electrode. The electrodes were pre-activated by being scanned between 1.1 and 1.6 V vs. RHE at a scan speed of 50 mV s⁻¹ for 30 cycles. The overpotentials applied for the OER experiments are OCP, 1.32, 1.54, 1.65, and back to OCP, controlled by a VSP 300 BioLogic potentiostat.

The Ir L₃-edge and Co K-edge XAS spectra were collected at a fluorescence mode using a Vertoex-ME4 4-element detector and a passivated implanted planar silicon (PIPS) detector, respectively. The acquisition time was adjusted between 6-40 seconds per spectrum to reduce the signal interference by the potential bubbling issue. Ir and Co foils were used to calibrate the energy shifts as well as to obtain the passive factor (S0²) for the extended X-ray absorption fine structure (EXAFS) fittings. Other metal oxides (IrO₂, CoO and Co₃O₄) were also measured as referential standards for the comparison with the X-ray absorption near edge structure (XANES) of different catalysts. All data processing was performed using the IFEFFIT package. (Ravel, B.; et. al. data analysis for X-ray absorption spectroscopy using IFEFFIT. Journal of synchrotron radiation 2005, 12 (4), 537-541).

Electrocatalyst ink was prepared by dispersing 5.0 mg freshly synthesized electrocatalyst powder in a mixture solution containing 742 μL DI water, 248 μL 2-propanol and 10 μL 5% Nafion solution, followed by sonication for 1 h in an ice-bath. Then, 5 μL ink was applied to a pre-polished glassy carbon electrode (Pine Research Instrument, diameter=5 mm, area 0.196 cm²).

All electrochemical experiments were performed using a CHI potentiostat (CHI 660D) in a standard three-electrode glass cell with a platinum foil as the counter electrode and an Ag/AgCl as the reference electrode (Pine Research Instrument). The 0.1M perchloric acid (HClO₄) were prepared by diluting 70% HClO₄ with DI water. The OER measurements were conducted in O₂-saturated 0.1 M HClO₄ solution at a rotating speed of 1600 rpm. The cyclic voltammetry (CV) and linear sweep voltammetry (LSV) curves were obtained with a scan rate of 5 mV s⁻¹. The reported data were based on three independent replicates.

For the long-term OER stability test using RDE setup, a pre-polished Au working electrode (Pine Research Instrument, diameter=5 mm, area 0.196 cm²) was used to avoid the effect of passivation of glassy carbon electrode on the stability test using the rotating disk electrode setup. In addition, carbon paper and platinized titanium felt were used for stability test at 10 and 100 mA cm⁻², respectively. All the potentials were corrected with 85% iR-compensation.

For the MEA test, the electrocatalyst coated membrane method was used. Commercial Pt/C (45.9 wt %) was used to prepare 0.1 mg_{Pt} cm⁻² loading of Pt at the cathode. The Ir loading at the anode was controlled between 0.006-0.1 mg_{Ir} cm⁻² on carbon paper. The Nafion ionomer to electrocatalyst ratio was selected to be 0.2 for both anode and cathode. After spraying, the electrocatalyst coated membranes were assembled. Nafion-212 proton exchange membrane was used for the activity test, while Nafion-115 was used for the stability test. The pre-heated de-ionized water was pumped into MEA and the cell temperature was maintained at 80° C. The geometric area of the MEA was 5 cm².

### Example 1—Synthesis & Characterization

### Synthesis

Ir—Co₃O₄ electrocatalysts were synthesized by an incipient wetness impregnation method using ammonium hexachloroiridate (III) hydrate ((NH₄)₃IrCl₆·xH₂O) and cobalt oxalate (CoC₂O₄·xH₂O) as precursors. For the synthesis of CoC₂O₄·xH₂O, 134.0 mg (1.0 mmol) sodium oxalate (Na₂C₂O₄) and 291.0 mg (1.0 mmol) cobalt nitrate hexahydrate (Co(NO₃)₂·6H₂O) was dissolved separately in 50 mL DI water. After stirring for 30 min, the cobalt nitrate solution was slowly added into the solution of sodium oxalate, followed by stirring for 2 h. Then, the precipitate was collected by centrifuge, washed by DI water, and dried overnight at 60° C. to provide CoC₂O₄·xH₂O.

### Ir—Co₃o₄ Bilayer

To synthesize the bilayer catalyst with an Ir loading of 5.2 wt %, 5.7 mg (NH₄)₃IrCl₆·xH₂O was dissolved in 0.2 mL DI water and dropwise added to 100.0 mg of CoC₂O₄·xH₂O. The obtained mixture was dried at 60° C. overnight, then calcined at 350° C. for 4 h in air with a heating rate of 1° C. min⁻¹. Ir—Co₃O₄ electrocatalysts with different Ir loading values were obtained by tuning the amount of (NH₄)₃IrCl₆·xH₂O and denoted as 1Ir—Co₃O₄, 3Ir—Co₃O₄, 7Ir—Co₃O₄, and 10Ir—Co₃O₄, corresponding to the Ir loading of 1.1 wt %, 3.0 wt %, 7.2 wt %, and 10.4 wt %, respectively.

### Ir—Co₃O₄ Cluster

As a comparator, Co₃O₄ was obtained through the calcination of CoC₂O₄·xH₂O precursor in air at 350° C. for 4 h. Using the Co₃O₄ as support, 5.0 wt % loading of Ir was introduced by adding the 0.2 mL solution containing 5.0 mg (NH₄)₃IrCl₆·xH₂O into 50.0 mg Co₃O₄. After calcination in air at 350° C. for 4 h, the cluster electrocatalyst was obtained.

### Characterization

Thermogravimetric analysis (TGA) indicated that when CoC₂O₄·xH₂O was used as support, the Ir and Co precursors decomposed simultaneously in air (see FIG. 2).

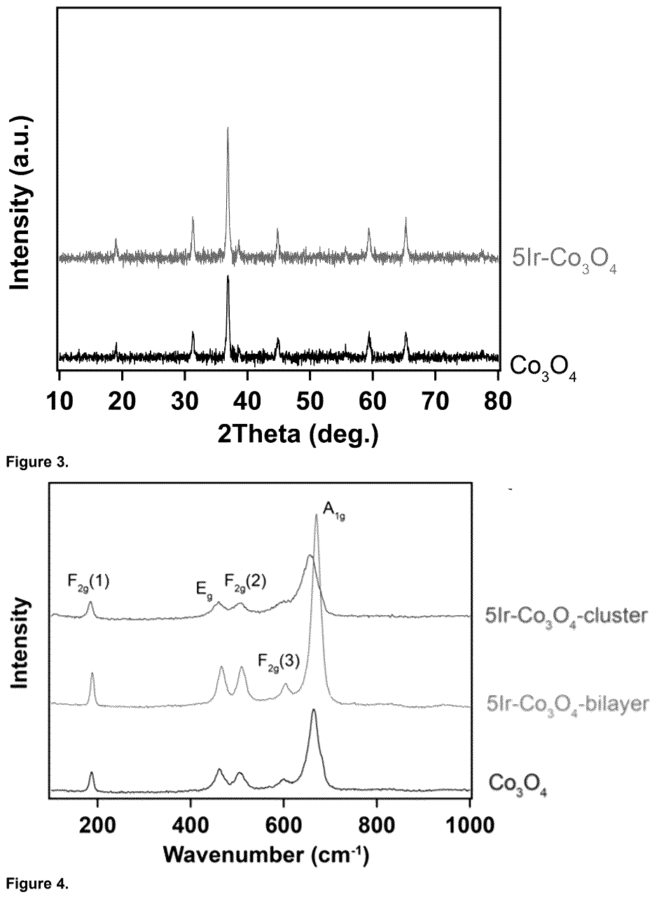

The formed mixed oxides were analyzed by powder X-ray diffraction (XRD). As shown in FIG. 3, the electrocatalyst exhibited similar diffraction patterns as the pristine Co₃O₄, which has the spinel structure with face-centered cubic symmetry (space group: Fd-3m). The Rietveld refinement analysis (not shown) indicated that the lattice parameters of Co₃O₄ remain almost unchanged for the Ir—Co₃O₄ electrocatalysts. This result is further corroborated by Raman spectroscopy and high-angle annular dark-field scanning transmission electron microscopy (HAADF-STEM) analyses.

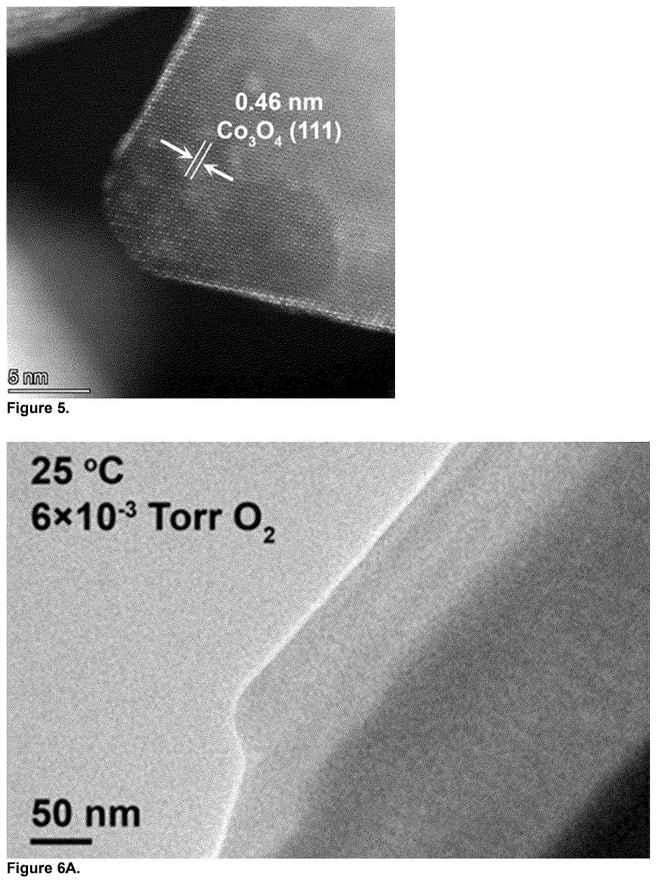

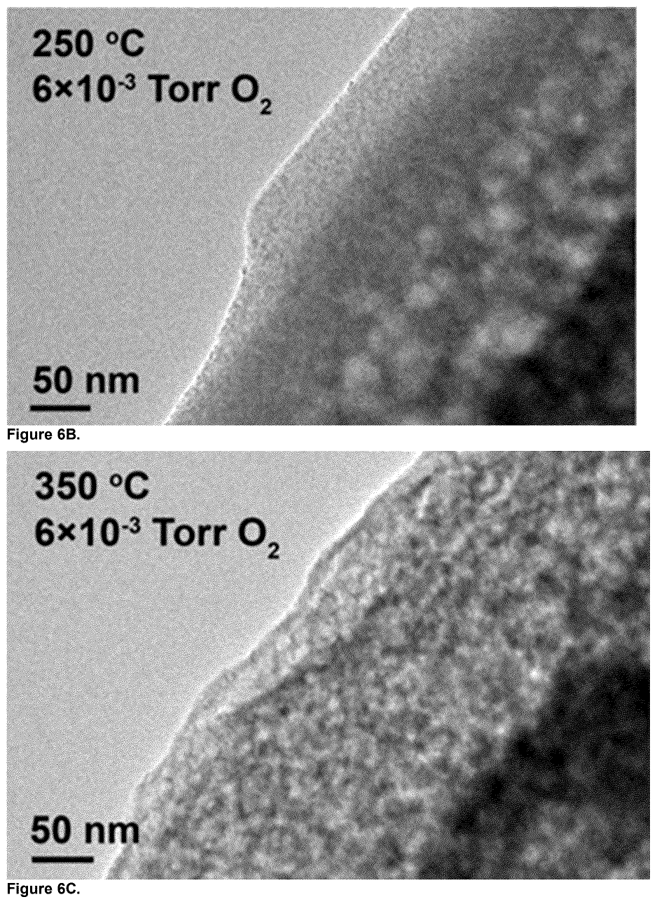

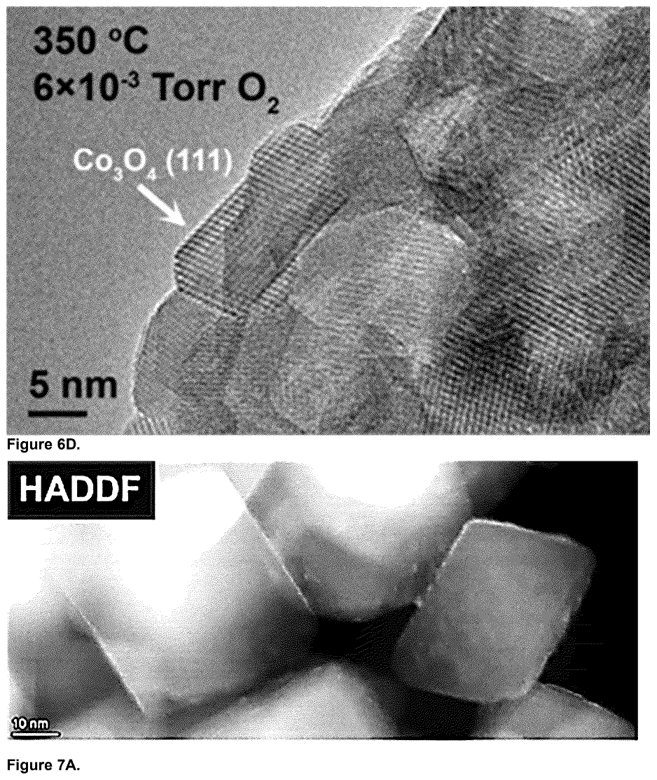

Compared to the pristine Co₃O₄, the peak positions for the Ir—Co₃O₄ electrocatalysts with varied Ir loading were unchanged in the Raman spectra (FIG. 4) which suggested a negligible influence of Ir species on the Co₃O₄ structure. HADDF-STEM images in FIG. 5 showed that two atomic layers of IrOₓ are present on the (111) facet of Co₃O₄ nanocrystals at an Ir loading of 5.2 wt %, designated as the bilayer electrocatalyst. As shown in FIGS. 6A-D, element mapping revealed that the lower loading of Ir (1.1 wt %) lead to a thinner and discontinued atomic layer of IrOₓ on the surface of Co₃O₄ nanocrystals (see FIG. 5). IrOₓ clusters were formed with increasing Ir loading to 10.4 wt %. Compared to the tetrahedral (Td) Co sites-terminated surfaces, IrOₓ formation on the octahedral (Oh)Co sites-terminated surfaces is believed to be more favorable due to the stronger binding energy of IrOₓ layers on the latter.

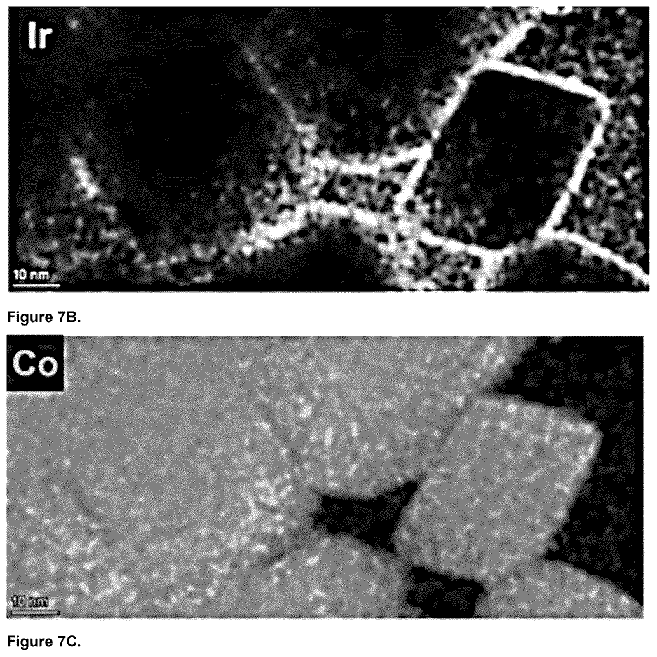

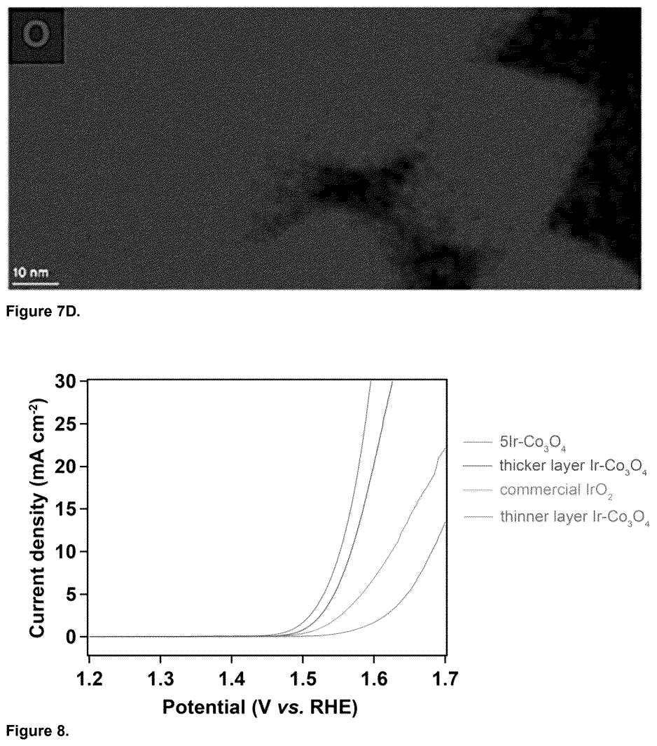

To track the formation of the bilayer electrocatalyst during sample preparation, in situ environmental transmission electron microscopy (E-TEM) was employed. As shown in FIGS. 7A-D, the TEM image revealed a rod-like Ir—Co precursor at 25° C. without obvious porous character. At 250° C., the precursor started decomposing in O₂, which lead to the formation of nanoparticles and introduced interparticle porosity. As the temperature increased to 350° C., the size of the nanoparticles decreased while the interparticle pore size increased. Similar to the HAADF-STEM analysis, the Co₃O₄(111) facet was observed.

For the comparator, when Co₃O₄ was used as the support, both Ir single atoms and IrOₓ clusters were observed. This was supported by the Raman analysis displayed in FIG. 4. The A_{1g} band of the cluster electrocatalyst exhibited a red-shift, while the F_{2g(1)} band shifted slightly, suggesting that Ir preferentially substituted the octahedral Co₃₊ sites over the tetrahedral Co²⁺ sites.²⁸ Compared to the IrOₓ atomic layers, the Ir clusters on the Co₃O₄ surface are more sensitive to the electron beam during HAADF-STEM measurements. The surface Ir species were observed to agglomerate, forming larger clusters after exposure to the electron beam in a short time (less than 5 min). The more stable structure of the bilayer electrocatalyst under the electron beam suggests a stronger interaction of the IrOₓ atomic layers with the Co₃O₄ surface than that of the IrOₓ clusters in the cluster electrocatalyst.

As demonstrated, when the iridium was present in an amount of less than 1.1 wt % (3 mol %), the iridium oxide was observed to form thinner and discontinued atomic layers on the surface of the cobalt oxide nanocrystals. When the iridium content is above 10.4 wt % (30 mol %), the iridium oxide was observed to aggregate into clusters rather than maintaining layered configurations on the cobalt oxide surface.

### Example 2—Evaluation of Electrocatalyst Activity With Oxygen Evolution Reaction (OER)

The electrocatalytic OER performance of the Ir—Co₃O₄ electrocatalysts was investigated on a glassy carbon electrode in O₂-saturated 0.1 M HClO₄ electrolyte using a rotating disk electrode (RDE) setup. The commercial IrO₂ and the pristine Co₃O₄ were also tested under the same conditions for comparison.

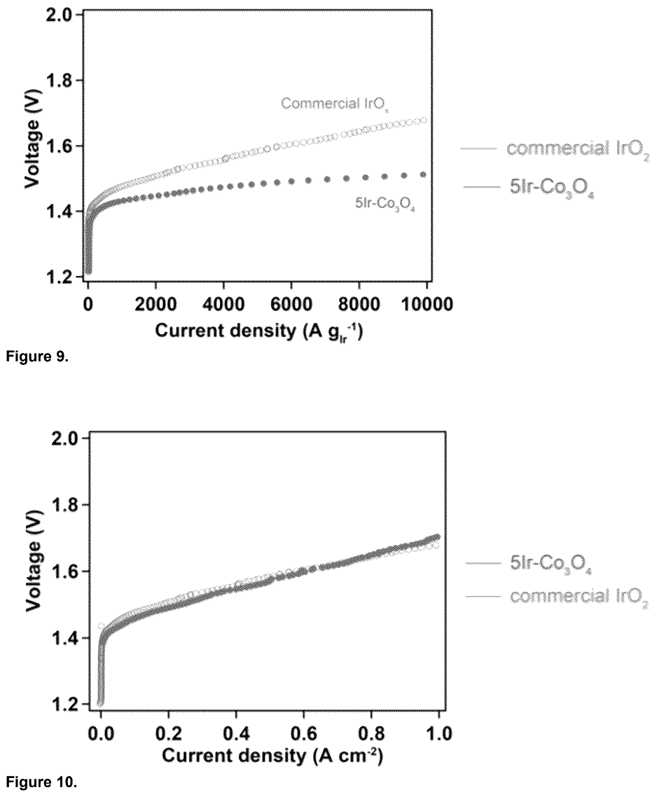

Overall, both the bilayer and cluster Ir—Co₃O₄ electrocatalysts exhibited better OER performance as compared to the pristine Co₃O₄ and the commercial IrO₂. FIG. 8 shows that the bilayer electrocatalyst exhibited the best OER activity among all electrocatalysts. An overpotential (η) of 316 mV was observed at a current density of 10 mA cm⁻². At an overpotential of 310 mV (1.54 V vs. RHE), the bilayer electrocatalyst shows a mass activity of 1056.2 A g_{Ir}⁻¹ (FIG. 9), which is much higher than that of commercial IrOₓ (79.5 A g_{Ir}⁻¹) or the cluster electrocatalyst (325.5 A g_{Ir}⁻¹). This result was supported by the smaller Tafel slope of the bilayer electrocatalyst (52.0 mV dec⁻¹) compared to that of commercial IrO₂ (53.5 mV dec⁻¹), the cluster electrocatalyst (55.6 mV dec⁻¹), and pristine Co₃O₄ (166.1 mV dec⁻¹). These data indicated the favorable OER kinetics of the bilayer electrocatalyst.

The electrochemical active surface area (ECSA) was estimated from the double-layer capacitance (C_{dl}) measurements. Among all the Ir—Co₃O₄ electrocatalysts, the bilayer electrocatalyst exhibited the highest ECSA, suggesting the highest density of active sites for the OER. Therefore, with the lower Ir loadings (1.1 wt % and 3.0 wt %), the lower densities of Ir—Co₃O₄ active sites is understood to play a role in their lower electrocatalytic activity. With higher Ir loadings (7.2 wt % and 10.4 wt %), the reduced use of Ir species resulted in lower mass activity. Nevertheless, the mass activities of all the bilayer and cluster Ir—Co₃O₄ electrocatalysts were higher than that of commercial IrO₂ as shown in FIG. 9. After normalization by ECSA, all the bilayer and cluster Ir—Co₃O₄ electrocatalysts exhibit higher current densities than that of the commercial IrO₂. At 1.54 V vs. RHE, the current densities for the bilayer electrocatalyst, the cluster electrocatalyst, and IrO₂ were 0.259, 0.194, and 0.024 mA cm_{ECSA}⁻², respectively.

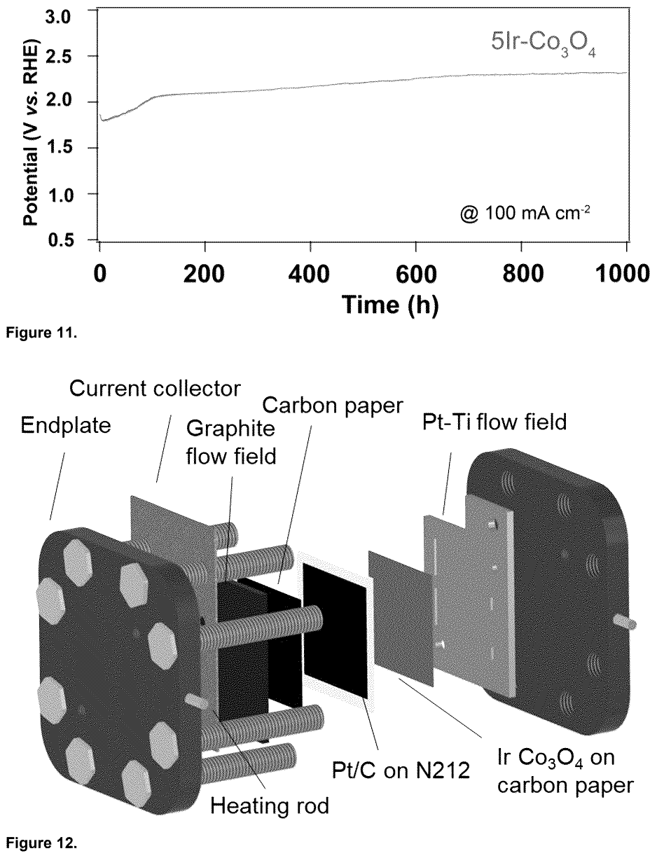

The long-term stability of the 5Ir—Co₃O₄ electrocatalysts under highly corrosive and oxidative conditions was investigated by constant current chronopotentiometry at different current densities. As shown in FIG. 10, both the bilayer and cluster Ir—Co₃O₄ electrocatalysts remained active for 1000 h at 10 mA cm⁻² with slow degradation rates of 0.05 mV h⁻¹ and 0.06 mV h⁻¹, respectively. At a higher current density of 100 mA cm⁻², the bilayer electrocatalyst exhibited an excellent durability for 1000 h with a slow degradation rate of 0.6 mV h⁻¹, while the cluster electrocatalyst deactivated drastically in 300 h with a degradation rate of 3.0 mV h⁻¹, as shown in FIG. 11. For comparison, the stability test of different electrocatalysts, including the commercial IrO₂ and the pristine Co₃O₄, were evaluated using the RDE setup. The activity and stability data of the bilayer and cluster Ir—Co₃O₄ electrocatalysts under OER conditions suggest that Ir—Co₃O₄ electrocatalysts outperformed commercial IrO₂ and the pristine Co₃O₄ in the RDE and demonstrate their potential for practical applications.

Inductively Coupled Plasma Optical Emission Spectroscopy (ICP-OES) analysis (not shown) of the electrolyte after the stability test showed that both the pristine Co₃O₄ and the commercial IrO₂ suffered from severe Co and Ir leaching, respectively, while both the bilayer and cluster Ir—Co₃O₄ electrocatalysts show much less dissolution of active species. These results indicate that the interaction between IrOₓ and Co₃O₄ improves the stability of the Ir—Co₃O₄ electrocatalysts by preventing ion dissolution from acid corrosion.

### Example 3—Evaluation of Electrocatalyst Activity With Larger Scale Membrane Electrode Assembly (MEA)

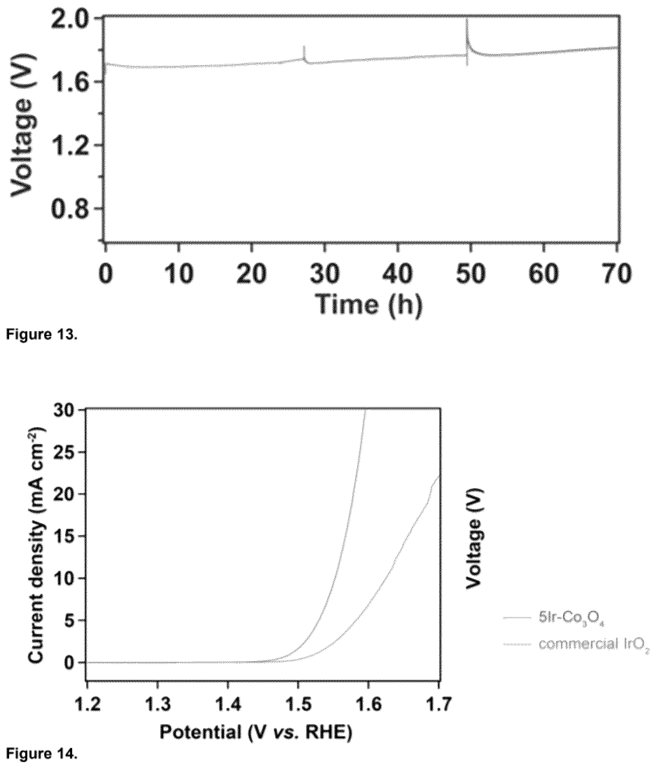

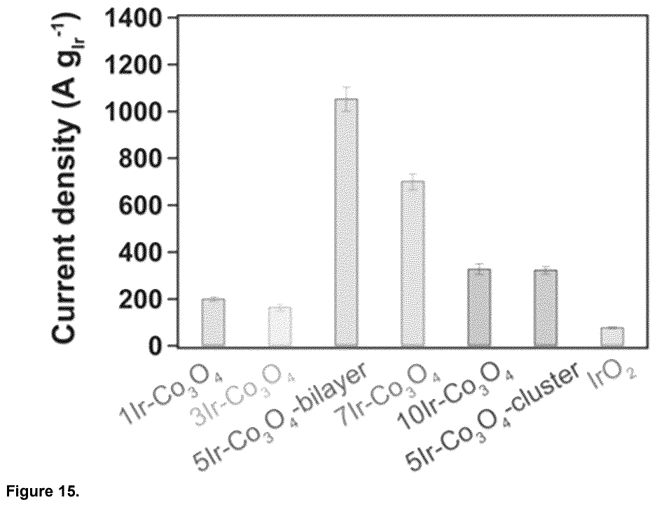

A scale-up performance test was further conducted using a MEA. FIG. 12 displays the configuration of the MEA setup. Nafion 212 and 115 membranes were used for the activity and stability test, respectively (Shown in FIG. 13). With the same loading amount of the electrocatalyst, the bilayer showed higher activity with the Nafion 212 than that of the Nafion 115. FIGS. 14 and 15 summarize the activity of different electrocatalysts from the MEA tests.

With the same Ir loading (0.10 mg_{Ir} cm⁻²), the activity of the bilayer electrocatalyst is comparable with the commercial IrO₂ and is much higher than that of the cluster electrocatalyst. At a cell potential of 1.5 V, the mass activity was 2372.0, 1780.3, and 94.2 A g_{Ir}⁻¹ for the bilayer electrocatalyst, commercial IrO₂, and the cluster electrocatalyst, respectively. Likewise, a higher mass activity was observed for the bilayer electrocatalyst (7617.2 A g_{Ir}⁻¹) as compared with the commercial IrO₂ (6021.8 A g_{Ir}⁻¹) when the Ir loading is further reduced to 0.006 mg_{Ir} cm⁻². However, the commercial IrO₂ deactivated rapidly at high potentials (>1.7 V), while the bilayer electrocatalyst remained active as shown in FIG. 13. In addition, for the commercial IrO₂ with an Ir loading of 0.10 mg_{Ir} cm⁻² and the bilayer electrocatalyst with an Ir loading of 0.006 mg_{Ir} cm⁻², the total mass loading of electrocatalyst is the same (0.12 mg_{cata} cm⁻²). With the same amount of electrocatalysts, the mass activity of the bilayer electrocatalyst (7617.2 A g_{Ir}⁻¹) is about 4 times higher than that of the commercial IrO₂ (1780.2 A g_{Ir}⁻¹) at a cell potential of 1.5V. These results suggest that when the Ir loading is 0.1 mg_{Ir} cm⁻², the large amount of bilayer electrocatalyst (2.0 mg_{cata} cm⁻²) used to prepare the electrode leads to the formation of a thick electrocatalyst layer, for which most of the active sites are in the bulk that are not accessible by water, resulting in a relatively low Ir mass activity.

### Example 4—Characterization of Electrocatalyst Under OER Conditions

In situ X-ray absorption spectroscopy (XAS) measurements were performed to identify the chemical states and local coordination environments of Ir and Co under OER conditions. The measurements began with the fresh sample, followed by sequential application of open circuit potential (OCP), 1.32 V, 1.54 V, 1.65 V (vs. RHE), and then back to OCP in 0.1 M HClO₄ solution.

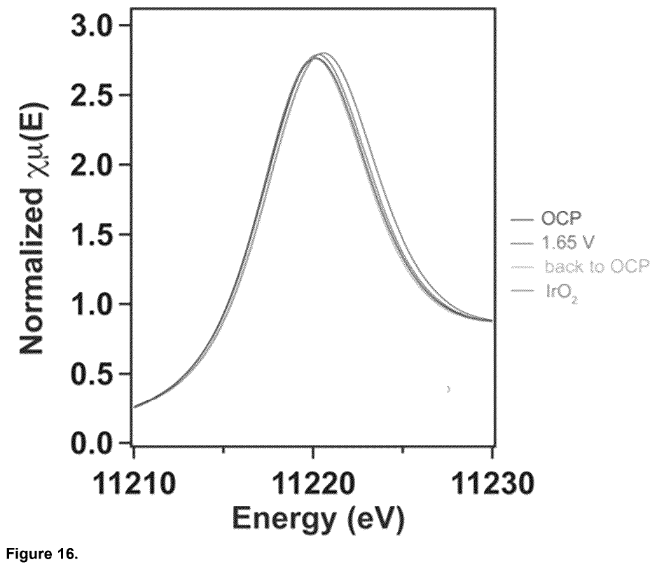

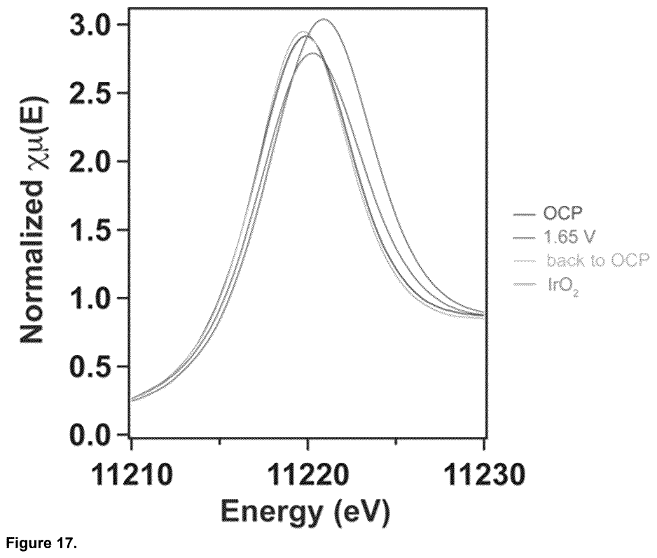

The Co K-edge X-ray absorption near edge structure (XANES) spectra for both samples closely match that of the Co₃O₄ reference standard, indicating that Co largely maintains its Co₃O₄ state. Moreover, the Co₃O₄ feature remained stable across all applied potentials. For the Ir L₃-edge spectra, the bilayer electrocatalyst under OER (FIG. 16) exhibited an oxidized state close to IrO₂, while the cluster electrocatalyst (FIG. 17) showed a slightly higher white line intensity and higher edge position than IrO₂, indicating a higher oxidation state than Ir⁴⁺. For both the bilayer and cluster Ir—Co₃O₄ electrocatalysts, Ir underwent slight reduction under OCP vs. RHE, but the reduced Ir ions were reoxidized at potentials above 1.32 V vs. RHE and returned to a reduced state once the potential was moved back to OCP.

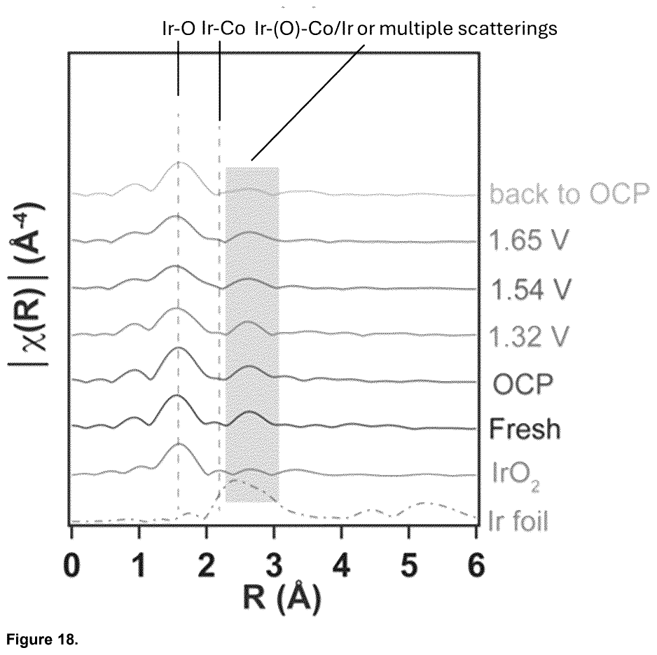

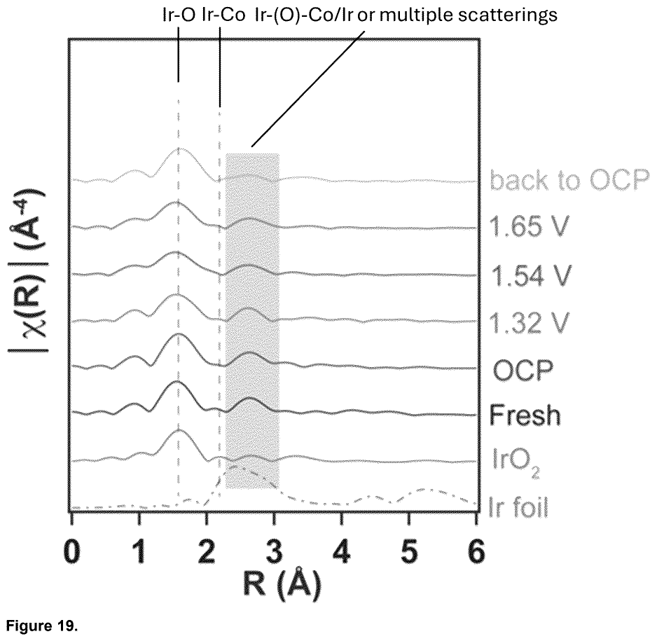

Extended X-ray absorption fine structure (EXAFS) analysis revealed the presence of Ir—O, Ir—Co/Ir, and Ir—(O)—Co/Ir bonds within the first three coordination shells (FIGS. 18 and 19). This data was evaluated to determine the evolution of average coordination numbers (CN) of the bilayer electrocatalyst under different conditions. The CNs of the Ir—O bond (CN_{Ir—O}) for the fresh sample and at OCP were generally around 6 with a bond length of ~2.0 Å in both samples, corresponding to octahedral coordination of Ir by O atoms. However, the CN_{Ir—O} for the bilayer electrocatalyst decreased slightly to 5.4-5.6 as the potential was varied from OCP to 1.65 V vs. RHE. Additionally, the σ² values, which indicate structural disorder, remained low (0.0028-0.0039 Å²) under various potentials, consistent with the uniform IrOₓ bilayer morphology observed in STEM imaging (Example 2).

In contrast, the cluster electrocatalyst exhibited a significant change in σ² values, which initially increased with potentials and then peaked at 0.0105 Å² at 1.54 V vs. RHE, reflecting a highly disordered structure. The structural disorder is understood to arise from the co-presence of multiple structural motifs (e.g., single atoms, clusters, and nanoparticles), as confirmed by STEM imaging, along with the dynamic behavior of these motifs under applied potentials. The highly disordered nature of the cluster electrocatalyst under OER conditions made a more quantitative comparison of the local environments difficult to provide.

After, the potentials were returned to OCP in order to assess the reversibility of the structures in both samples. The bilayer electrocatalyst was observed to nearly fully regain its octahedral Ir coordination. In contrast, the cluster electrocatalyst sample exhibited only partial recovery, maintaining a relatively high degree of structural disorder. This suggested that the applied potentials served as driving forces that influenced structural ordering and morphology, and the bilayer electrocatalyst maintained a well-defined and reversible structure.

### Example 5—Evaluation of Electrocatalyst Activity With Oxidation of Hydrocarbons

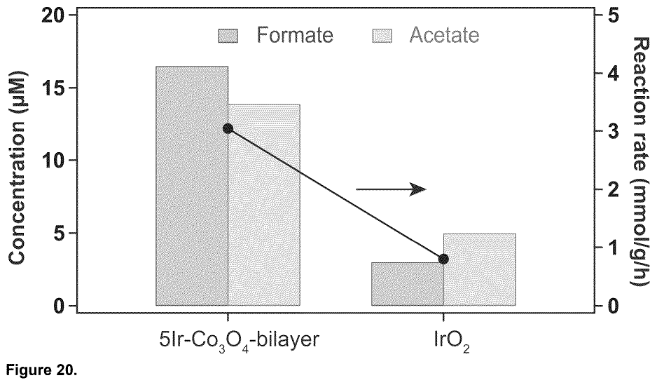

The prepared bilayer Ir—Co₃O₄ catalyst can also be effectively applied to the electrochemical oxidation of hydrocarbons. As shown in FIG. 20, the concentrations and corresponding reaction rates of formate and acetate products generated during the electrochemical oxidation of methane with the prepared bilayer Ir—Co₃O₄ electrocatalyst. Compared to commercial IrO₂, the bilayer Ir—Co₃O₄ electrocatalyst demonstrates substantially enhanced catalytic activity. The concentrations of both formate and acetate are about three times higher than those obtained using IrO₂, highlighting its superior catalytic efficiency. These results underscore the strong potential of the bilayer Ir—Co₃O₄ catalyst for efficient hydrocarbon conversion and its promise for broader applications in electrochemical oxidation processes.

What is claimed is:

1. A method of making an electrocatalyst, comprising:
admixing a precious metal oxide precursor with a transition metal oxide precursor;
drying the admixture;
heating the admixture, wherein a decomposition temperature of the transition metal oxide precursor and a decomposition temperature of the precious metal oxide precursor have difference of no more than 100° C.; and
upon heating, the precious metal oxide precursor and the transition metal oxide precursor decompose substantially simultaneously and thereby form nanocrystals having a transition metal oxide core and one or more precious metal oxide layers surrounding the core;
wherein each of the one or more precious metal oxide layers is an atomically thin layer.

2. The method of claim 1, wherein admixing comprises dropwise adding the precious metal oxide precursor to the transition metal oxide precursor.

3. The method of claim 1, comprising selecting the ratio of the precious metal precursor to the transition metal oxide precursor such that two layers of precious metal oxide deposit on the transition metal oxide nanocrystals.

4. The method of claim 1, wherein the transition metal is one or more of cobalt, iron, nickel, manganese, and copper.

5. The method of claim 1, wherein the transition metal oxide precursor comprises one or more of a transition metal carbonate, transition metal hydroxide, transition metal nitrate, transition metal chloride, and transition metal oxalate.

6. The method of claim 1, wherein the precious metal is one or more of iridium, platinum, gold, ruthenium, and rhodium.

7. The method of claim 1, wherein the precious metal oxide precursor comprises a salt of iridium, platinum, gold, ruthenium, or rhodium.

8. The method of claim 7, wherein the precious metal oxide precursor is an iridium salt.

9. The method of claim 1, wherein the admixture is heated to a temperature in a range of about 250° C to about 500° C.

10. The method of claim 1, further comprising heating the admixture with a rate in a range of about 0.5° C./min to about 2.0° C./min.

11. An electrocatalyst for a chemical process, comprising:
a plurality of nanocrystals, each nanocrystal comprising a transition metal oxide core and one or more layers of a precious metal oxide surrounding the core;
wherein:
each layer of the precious metal oxide is an atomically thin layer and has a substantially uniform thickness of about 50 pm to about 500 pm; and
the precious metal oxide is present in an amount of about 1 mol % to about 50 mol % based on the total weight of the electrocatalyst.

12. The electrocatalyst of claim 11, wherein the transition metal oxide is one or more of cobalt oxide, iron oxide, nickel oxide, manganese oxide, and copper oxide.

13. The electrocatalyst of claim 11, wherein the precious metal oxide comprises one or more of iridium oxide, platinum oxide, gold oxide, ruthenium oxide, and rhodium oxide.

14. The electrocatalyst of claim 11, wherein the precious metal oxide is iridium oxide and thickness of each layer of iridium oxide is about 200 pm to about 300 pm.

15. The electrocatalyst of claim 12, wherein the transition metal oxide is cobalt oxide.

16. The electrocatalyst of claim 11, wherein the precious metal oxide is platinum oxide or gold oxide and the transition metal oxide core is nickel oxide or copper oxide.

17. The electrocatalyst of claim 11, wherein the precious metal oxide is ruthenium oxide or rhodium oxide and the transition metal oxide core is iron oxide or manganese oxide.

18. The electrocatalyst of claim 11, wherein the precious metal oxide is iridium oxide and the transition metal oxide core is cobalt oxide.

19. A method of performing an oxygen evolution reaction, comprising:
providing an electrochemical cell, comprising:
an anode, comprising the electrocatalyst of claim 11;
a cathode;
an electrolyte; and
an electrical source;
applying an electrical bias to the anode;
exposing the electrocatalyst to a source comprising water, wherein upon contacting the electrocatalyst under the electrical bias, the water of the source is decomposed into a plurality of OER intermediates; and
maintaining the electrical bias, thereby converting the plurality of OER intermediates into oxygen gas.

20. A method of oxidizing hydrocarbons, comprising:
providing an electrochemical cell, comprising:
an anode, comprising the electrocatalyst of claim 11;
a cathode;
an electrolyte; and
an electrical source;
applying an electrical bias to the anode;
exposing the electrocatalyst to a source comprising hydrocarbons, wherein upon contacting the electrocatalyst, the hydrocarbons decompose into a plurality of hydrocarbon intermediates; and
maintaining the electrical bias, thereby converting the plurality of hydrocarbon intermediates into carboxylic acids or carboxylates.
